(19) United States
(12) Patent Application Publication
(10) Pub. No.: US 2013/0344923 A1
(43) Pub. Date: Dec. 26, 2013

(54) Cell Phone Accessory

(71) Applicants: Alen MADATYAN, Glendale, CA (US); Henry MADATYAN, Glendale, CA (US)

(72) Inventors: Alen MADATYAN, Glendale, CA (US); Henry MADATYAN, Glendale, CA (US)

(21) Appl. No.: 13/533,856

(22) Filed: Jun. 26, 2012

(51) Int. Cl. H04W 88/02

(52) U.S. Cl. 455/575.1

(57) ABSTRACT

An ornamental accessory for removable interconnection with a conventional cell phone having a headphone jack. The ornamental accessory here includes an ornamental body portion and a connector plug connected to the ornamental body portion. The connector plug is constructed and arranged to be closely received within the cell phone headphone jack to protect the headphone jack from debris and other external contamination. The ornamental body portion can take on several attractive shapes so as to uniquely “dress up” and personalize the cell phone.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to accessories for electronic devices. More particularly, the invention concerns an ornamental accessory for cell phones.

2. Description of Related Art Including Information Disclosed Under 37 CFR 1.97 and 1.98

Millions of people around the world use cellular phones for a great variety of purposes. Modern day cell phones provide an incredible array of functions. For example, the cell phone can be used to store various types of information, to send or receive e-mail, to send text messages, to take photographs, to obtain information from the Internet, to play games and to perform a number of other functions.

While cell phones are commercially available from a number of manufactures, they all exhibit a quite similar vanilla and basically uninteresting appearance. Additionally, most are provided with headphone jacks of standard construction. The typical headphone jack comprises a small round connector that is designed to accept a generally pin-shaped plug of the character found on a standard phone headset. The jack can also be used with accessories such as a wired, hands-free speakerphone. The diameter of the typical headphone jack is 3.5 millimeters (mm) and this headphone jack accepts music headphones and various devices other than headphones.

The thrust of the present invention is to provide ornamental accessories that can be conveniently plugged into the cell phone headphone jack so as to uniquely “dress up” and personalize the cell phone.

### BRIEF SUMMARY OF THE INVENTION

By way of brief summary, one form of the ornamental accessory of the invention, which is designed to be removably interconnected with a conventional cell phone of the character having a head phone jack, comprises an ornamental body portion and a connector plug connected to the ornamental body portion and extending therefrom, the connector plug being constructed and arranged to be closely received within the cell phone head jack. The ornamental body portion of the accessory can take on several attractive shapes so as to uniquely “dress up” and personalize the cell phone.

With the forgoing in mind, it is an object of the invention to provide a novel cell accessory of the character described in which the connector plug portion of the accessory is uniquely designed him to be closely received within the cell phone head jack.

Another object of the invention is to provide a cell phone accessory of the character described in the preceding paragraph, which, when connected to the cell phone, effectively protects the headphone jack from debris and other external contamination.

Another object of the invention is to provide a cell phone accessory of the aforementioned character in which the ornamental body portion of the accessory can take on several attractive shapes so as to uniquely “dress up” and personalize the cell phone.

Another object of the invention is to provide a cell phone accessory of the aforementioned character that can be easily interconnected with and separated from the cell phone.

Another object of the invention is to provide a cell phone accessory of the class described in the preceding paragraphs that can be easily and inexpensively manufactured in quantity.

### BRIEF DESCRIPTION OF SEVERAL VIEWS OF THE DRAWINGS

FIG. 1 is a front view of one form of ornamental accessory of the invention for removable interconnection with a conventional cell phone.

FIG. 2 is an exploded, front view of the form of the invention illustrated in FIG. 1, partly broken away to show internal construction showing the ornamental accessory of FIG. 1 exploded from a conventional cell phone.

FIG. 3 is a front view of one form of the present invention partly broken away to show internal construction showing the ornamental accessory of FIG. 1 interconnected with a conventional cell phone.

FIG. 4 is a front view of an alternate form of ornamental accessory of the invention for removable interconnection with a conventional cell phone.

FIG. 5 is a front view of still another form of ornamental accessory of the invention for removable interconnection with a conventional cell phone.

### DETAILED DESCRIPTION OF THE INVENTION

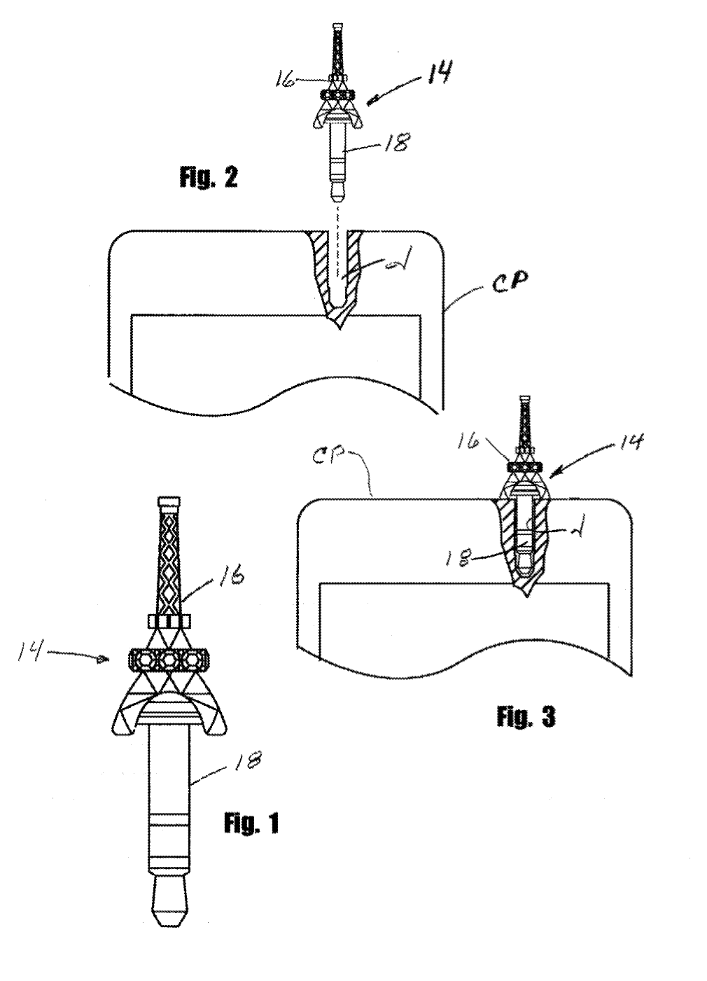

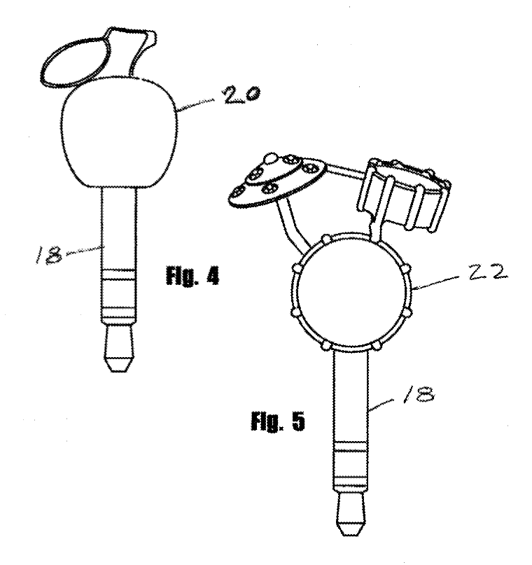

Referring to the drawings and particularly to FIG. 1, one form of the cell phone accessory of the present invention is there illustrated and generally designated by the numeral 14. Accessory 14 is specially designed for removable interconnection with a conventional cell phone “CP” having a head phone jack “J”. Ornamental accessory 14 here comprises an ornamental body portion 16 and a connector plug 18 that is suitably connected to the ornamental body portion. As depicted in FIGS. 2 and 3 of the drawings, connector plug 18 is specially constructed and arranged to be closely received within the cell phone head jack “J”. In the present form of the invention, connector plug 18 is generally circular in cross-section at any point, has a diameter of about 3.5 millimeters (mm) and has a length of approximately 17 millimeters (mm) so as to conveniently fit within a conventional headphone jack of the character having a diameter of about 3.5 millimeters (mm) and a depth of on the order of 17 millimeters (mm). Connector plug 18 comprises a TRS connector (tip, ring, sleeve) and is a common type of connector of the character typically used for analog signals including audio.

It is to be understood that the ornamental body portion of the ornamental accessory of the invention can take any number of forms depending on the particular desire of the user. In the form of the invention shown in FIGS. 1 through 3 of the drawings, the ornamental body portion 18 of the ornamental accessory comprises a depiction of a geographical land mark. More particularly, the ornamental body portion 18 is here shown as a replica of the Eiffel Tower.

In the form of the invention shown in FIG. 4 of the drawings, the ornamental body portion 20 of the ornamental accessory comprises a depiction of a piece of fruit. More particularly, the ornamental body portion 20 is here shown as a replica of an apple.

In the form of the invention shown in FIG. 5 of the drawings, the ornamental body portion 22 of the ornamental accessory comprises a depiction of a musical instrument. More particularly, the ornamental body portion 22 is here shown as a replica of a drum set.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An ornamental accessory for removable interconnection with a conventional cell phone having a headphone jack, said ornamental accessory comprising an ornamental body portion and a connector plug connected to said ornamental body portion, said connector plug being constructed and arranged to be closely received within the cell phone headphone jack.

2. The ornamental accessory as defined in claim 1 in which said connector plug has a length of approximately 17 millimeters.

3. The ornamental accessory as defined in claim 1 in which said connector plug is generally cylindrical in shape and has a diameter of about 3.5 millimeters.

4. The ornamental accessory as defined in claim 1 in which said ornamental body portion of said ornamental accessory comprises a depiction of the Eiffel tower.

5. The ornamental accessory as defined in claim 1 in which said ornamental body portion of said ornamental accessory comprises a depiction of an apple.

6. The ornamental accessory as defined in claim 1 in which said ornamental body portion of said ornamental accessory comprises a depiction of a drum set.

7. An ornamental accessory for removable interconnection with a conventional cell phone having a headphone jack, said ornamental accessory comprising an ornamental body portion and a generally cylindrical connector plug connected to said ornamental body portion, said connector plug having a diameter of about 3.5 millimeters and a length of approximately 17 millimeters.
